(19) United States
(12) Patent Application Publication
(10) Pub. No.: US 2025/0157759 A1
(43) Pub. Date: May 15, 2025

(54) AIR CIRCUIT BREAKER HAVING ARC COVER

(71) Applicant: LS ELECTRIC CO., LTD., Anyang-si, Gyeonggi-do (KR)

(72) Inventor: Kyu Ho LEE, Anyang-si, Gyeonggi-do (KR)

(21) Appl. No.: 18/837,282

(22) PCT Filed: Feb. 2, 2023
(86) PCT No.: PCT/KR2023/001529

§ 371 Date: Aug. 9, 2024

(30) Foreign Application Priority Data
Mar. 3, 2022 (KR) 10-2022-0027198

(51) Int. Cl. H01H 33/08

(52) U.S. Cl. CPC H01H 33/08

(57) ABSTRACT

Disclosed is an air circuit breaker having an arc cover, capable of preventing a secondary accident caused by arc generation. The air circuit breaker, according to one aspect of the present disclosure, may comprise: an operation unit in which arc is generated by the operation of a movable contact with respect to a stationary contact; an extinguishing unit which is installed on the upper part of the operation unit and primarily extinguishes the arc; and an arc cover which is installed on the upper part of the extinguishing unit, has a chamber formed, enabling the retention of high-temperature gas which has passed through the extinguishing unit, and has at least one or more guide panels partitioning the inside of the chamber into a plurality of sections and having an opening on one side, thereby enabling the high-temperature gas to flow along a flow path guided by the guide panels and be discharged through an outlet in a first direction.

### CROSS-REFERENCE TO RELATED APPLICATIONS

This application is the National Stage filing under 35 U.S.C. 371 of International Application No. PCT/KR2023/001529, filed on Feb. 2, 2023, which claims the benefit of earlier filing date and right of priority to Korean Application No. 10-2022-0027198, filed on Mar. 3, 2022, the contents of which are all hereby incorporated by reference herein in their entirety.

### FIELD

The present invention relates to an air circuit breaker, and more particularly, to an air circuit breaker having an arc cover capable of preventing a secondary accident caused by arc generation.

### BACKGROUND

Generally, circuit breakers according to the related art block currents and protect power systems and load devices when devices that receive power from transmission and substation systems or lines are opened or closed or when accidents such as overloads or short circuits occur.

The circuit breaker according to the related art is provided with a movable contact and a stationary contact in contact with the movable contact, the current flows in the line when the movable contact is in contact with the stationary contact, and the movable contact is separated from the stationary contact to block the current in the line when a high current flows in the line due to the accident.

Recently, as the electric capacity of the power system has increased, high-current electrification of the circuit breaker is required.

The air circuit breaker according to the related art blocks a fault current within a short period of time when a short circuit occurs for user safety and system integrity. When a high fault current is blocked, a conductive arc inside an arc extinguishing unit is discharged to the outside of the arc extinguishing unit, a conductive hot gas is discharged together and electrified with an adjacent switchboard or the like, and thus secondary accidents occur.

### SUMMARY

The present invention is created to solve the above problems, and the present invention is directed to providing an air circuit breaker having an arc cover, in which a high-temperature gas primarily extinguished by an arc extinguishing unit stays inside a chamber having a certain space so that conductivity is decreased when the gas is discharged and is then induced to be discharged, thereby preventing secondary accidents in advance.

The aspects of the present invention are not limited to the aspects described above, and those skilled in the art to which the present invention pertains will clearly understand other aspects not described from the following description.

### Technical Solution

According to an aspect of the present invention, an air circuit breaker having an arc cover includes an operation unit in which arc is generated by operating a movable contact with respect to a stationary contact, an arc extinguishing unit that is installed on an upper side of the operation unit and primarily extinguish the arc, and an arc cover which is installed on an upper side of the arc extinguishing unit, has a chamber formed such that a high-temperature gas passing through the arc extinguishing unit stays therein, and has at least one guide panel partitioning an interior of the chamber into a plurality of parts and having an opening on one side thereof, and in which the high-temperature gas is discharged to an outlet in a first direction along a passage guided by the guide panel.

The arc cover may be formed such that a cross-sectional area of an inlet through which the high-temperature gas is introduced is greater than a cross-sectional area of the outlet.

The guide panel of the arc cover may be installed horizontally or inclined with respect to a horizontal plane.

An inner rib may be vertically formed in an inner side surface of the arc cover and the guide panel.

The inner rib may be formed in an arch shape.

The inner rib may be formed as a plurality of inner ribs, and each inner rib may protrude at a different height.

An outer rib may be vertically formed on an outer side surface of the arc cover, and the outer rib and the inner rib may be formed at positions corresponding to each other.

The guide panel may be formed as a plurality of guide panels.

The outlet in the first direction may be formed on a front upper side or both side surfaces of the air circuit breaker.

A sealing member may be installed between the arc extinguishing unit and the arc cover to prevent the high-temperature gas from leaking.

A shield panel, in which a plurality of through-holes are formed, may be installed between the arc extinguishing unit and the arc cover to control a flow rate of the gas.

The shield panel may be coupled to or integrally formed with a lower end of the arc cover.

A closed part of the shield panel in which the through-holes are not formed may be positioned below an opening formed by the guide panel.

According to the above configuration, an air circuit breaker having an arc cover according to the present invention may be provided with an arc cover having a guide panel so that flow of a fluid is changed, thereby sufficiently removing conductivity of gas.

Further, in an air circuit breaker having an arc cover according to the present invention, gas is guided inside a chamber of the arc cover by a shield panel, a guide panel, and an arch-shaped inner rib and flows for a sufficient time, and thus secondary accidents caused by conductivity of the gas can be prevented in advance.

The effects of the present invention are not limited to the above effects and should be understood to include all effects that may be deduced from the detailed description of the present invention or the configuration of the present invention described in the appended claims.

### BRIEF DESCRIPTION OF THE DRAWINGS

FIG. 1 is a perspective view illustrating an air circuit breaker having an arc cover according to an embodiment of the present invention.

FIG. 2 is an exploded perspective view in which the arc cover of the air circuit breaker having the arc cover according to the embodiment of the present invention is separated.

FIG. 3 is a perspective view of the arc cover and an arc extinguishing unit that are some components of the air circuit breaker having the arc cover according to an embodiment of the present invention.

FIG. 4 is an exploded perspective view of the arc cover and the arc extinguishing unit that are some components of the air circuit breaker having the arc cover according to the embodiment of the present invention.

FIG. 5 is a partially cutaway perspective view of the arc cover and the arc extinguishing unit that are some components of the air circuit breaker having the arc cover according to the embodiment of the present invention.

FIG. 6 is a cross-sectional view of the arc cover and the arc extinguishing unit that are some components of the air circuit breaker having the arc cover according to an embodiment of the present invention.

FIG. 7 is a perspective view of the arc cover that is a component of the air circuit breaker having the arc cover according to the embodiment of the present invention.

FIG. 8 is a perspective view of the arc cover that is a component of the air circuit breaker having the arc cover according to the embodiment of the present invention when viewed from below.

FIG. 9 is a perspective view of a shield panel that is a component of the air circuit breaker having the arc cover according to the embodiment of the present invention.

FIG. 10 is a perspective view of an air circuit breaker having an arc cover according to another embodiment of the present invention.

FIG. 11 is a partially cutaway perspective view of the arc cover that is a component of the air circuit breaker having the arc cover according to another embodiment of the present invention.

FIG. 12 is a cross-sectional view of the arc cover that is a component of the air circuit breaker having the arc cover according to another embodiment of the present invention.

### DETAILED DESCRIPTION

Hereinafter, embodiments of the present invention will be described in detail with reference to the accompanying drawings so that those skilled in the art to which the present invention pertains may easily implement the present invention. The present invention may be implemented in various different forms and is not limited to the embodiments described herein. In the drawings, parts irrelevant to the description are omitted in order to clearly describe the present invention, and the same reference numerals are assigned to the same or similar components throughout the specification.

Terms or words used in the present specification and the appended claims are not limitedly interpreted as usual or dictionary meanings and should be interpreted as meanings and concepts corresponding to the technical spirit of the present invention based on the principle that the inventor may appropriately define the concepts of the terms in order to describe his/her disclosure in the best way.

Therefore, since the embodiments described in the present specification and configurations illustrated in the drawings correspond to the exemplary embodiments of the present invention and do not represent all the technical spirit of the present invention, the corresponding configurations may have various equivalents and modifications to replace them at a time of filing the present invention.

It should be understood in the present specification that the terms “include” or “have” are intended to describe that there are features, numbers, steps, operations, components, parts, or combinations thereof that are described in the specification and do not exclude in advance the possibility of the presence or addition of one or more other features, numbers, steps, operations, components, parts, or combinations thereof.

A case in which a component is present on a “front side,” a “rear side,” an “upper side,” or a “lower side” of another component includes a case in which the component is disposed on the “front side,” the “rear side,” the “upper side,” or the “lower side” in direct contact with the another component as well as a case in which still another component is disposed therebetween, unless otherwise specified. Further, a case in which a first component is “connected” to a second component includes a case in which the first component and the second component are indirectly connected to each other as well as a case in which the first component and the second component are directly connected to each other unless otherwise specified.

Hereinafter, an air circuit breaker having an arc cover according to an embodiment of the present invention will be described with reference to the accompanying drawings.

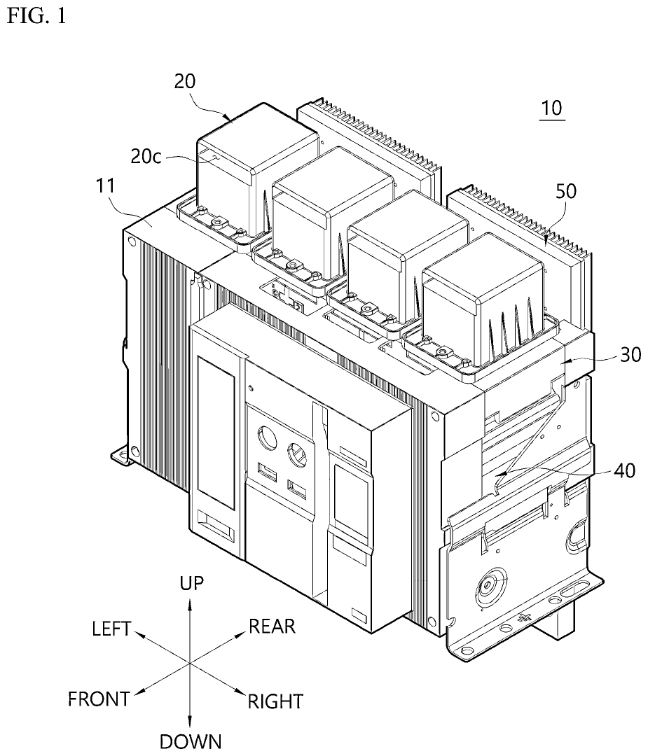

Referring to FIGS. 1 to 9, an air circuit breaker 10 having an arc cover according to the embodiment of the present invention includes an operation unit 40, an arc extinguishing unit 30, and an arc cover 20.

Referring to FIG. 1, an external appearance of the air circuit breaker 10 having the arc cover according to an embodiment of the present invention is illustrated. The air circuit breaker 10 has a generally rectangular parallelepiped shape, and a case 11 is provided outside the air circuit breaker 10 to protect internal components. Inside the air circuit breaker 10, the operation unit 40 equipped with a stationary contact and a movable contact controls a current, and in this case, an arc is generated in this portion. The arc extinguishing unit 30 for primarily extinguishing the generated arc is provided on an upper side of the operation unit 40 provided inside the case 11. The arc cover 20 for secondarily managing a high-temperature gas that rises from the arc extinguishing unit 30 is fixedly installed at an upper end of the arc extinguishing unit 30, herein, at a position corresponding to an upper surface of the case 11. In this case, an outlet 20c is formed in a forward direction of the arc cover 20 so that the gas managed by the arc cover 20 may be discharged to the front side. A busbar 50 is installed behind the case 11, and in this case, it is not preferable that the gas be discharged to the rear side.

In this case, the air circuit breaker 10 may be classified into a so-called fixed type air circuit breaker and a so-called draw-out type air circuit breaker. The fixed type air circuit breaker is a type in which internal components are fixedly installed and difficult to replace, and the draw-out type air circuit breaker is known to be a type in which various components may be draw-out and replaced depending on states of the internal components. When it is difficult to replace the internal components as in the fixed type air circuit breaker, secondary accidents may occur more frequently. Thus, in the case of the fixed type air circuit breaker, it is very effective to apply the present invention.

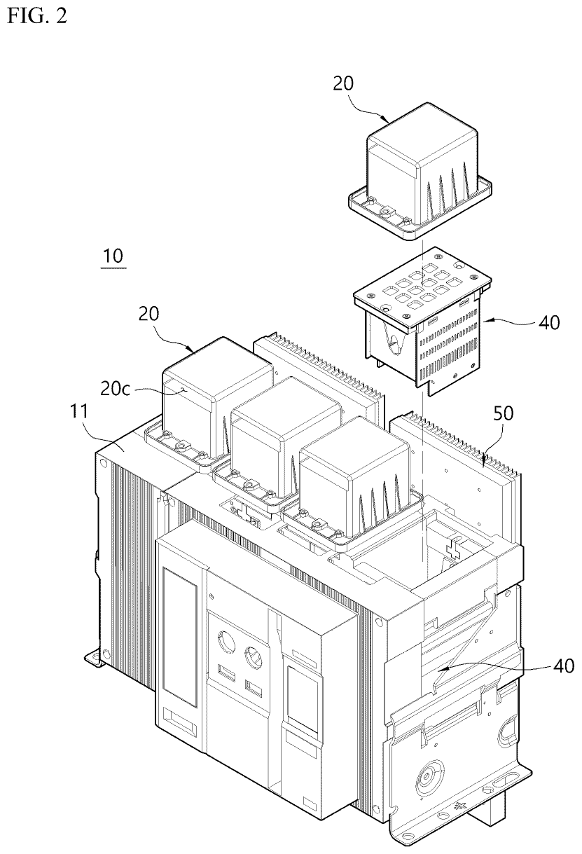

Referring to FIGS. 1 and 2, the operation unit 40 may generate an arc as the movable contact is operated with respect to the stationary contact. The configuration of the operation unit 40 is the same as the related art, and thus herein, a detailed description thereof will be omitted.

Referring to FIGS. 1 to 6, the arc extinguishing unit 30 is installed on an upper side of the operation unit 40 and primarily extinguishes the arc. A support plate 33 is installed on a side surface of the arc extinguishing unit 30, and an arc guide is installed on a lower side of the arc extinguishing unit 30. An upper cover panel 36 is installed on an upper side of the arc extinguishing unit 30, and a plurality of grids 32 vertically standing are installed at regular intervals inside the arc extinguishing unit 30. The arc generated in the operation unit 40 is extinguished while passing between the grids 32 of the arc extinguishing unit 30 and passes through a through-hole 36a of the upper cover panel 36 and rises into a chamber 20a of the arc cover 20. In this case, the arc is primarily extinguished by the arc extinguishing unit 30, and the high-temperature gas moves upward to the chamber 20a of the arc cover 20.

Referring to FIGS. 1 to 9, the arc cover 20 is installed on the upper side of the arc extinguishing unit 30, the chamber 20a is formed so that the high-temperature gas passing through the arc extinguishing unit 30 may stay, at least one guide panel 23 by which an interior of the chamber 20a is partitioned into a plurality of parts and in which an opening is formed on one side thereof may be provided, and the high-temperature gas may be discharged to the outlet 20c formed on a front surface of the air circuit breaker 10 along a passage guided by the guide panel 23. Referring to FIGS. 1 and 2, the arc cover 20 is generally formed in a rectangular parallelepiped shape, and a lower surface thereof is open so that the high-temperature gas may be introduced into the chamber 20a due to a rising pressure thereof, may pass through a passage according to guide of the guide panel 23, and may be exhausted to the outlet 20c formed on the front surface. Here, one guide panel 23 is installed, but a plurality of guide panels 23 may be formed.

In this case, the arc cover 20 may be formed such that a cross-sectional area of an inlet through which the high-temperature gas is introduced is greater than a cross-sectional area of the outlet 20c. That is, a cross-sectional area through which the high-temperature gas introduced from the lower arc extinguishing unit 30 passes may be formed to be larger than a cross-sectional area of the outlet 20c through which the gas is discharged from the arc cover 20. Of course, this cross-sectional area ratio may be optimized through an experiment in consideration of both a design condition, the temperature of the arc generated in the internal operation unit 40, or the like.

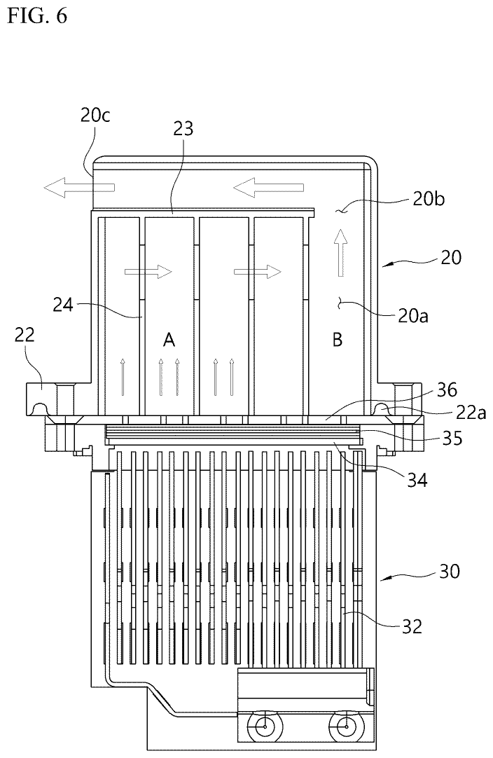

In this case, referring to FIG. 9, the shield panel 34 is installed below the upper cover panel 36, the shield panel 34 is installed between the arc extinguishing unit 30 and the arc cover 20, and a plurality of through-holes 34a are formed only in a portion of the shield panel 34. That is, the shield panel 34 may include an open part A in which the plurality of through-holes 34a are formed, and a closed part B in which the through-holes 34a are not formed. Here, the number or shape of the through-holes 34a may be designed according to design of a cross-sectional area of the shield panel 34, through which the high-temperature gas passes. Further, the closed part B may be positioned below an opening 20b formed by the guide panel 23. As the guide panel 23 and the shield panel 34 are arranged and formed in this way, flow of the high-temperature gas as illustrated in FIG. 6 may be induced.

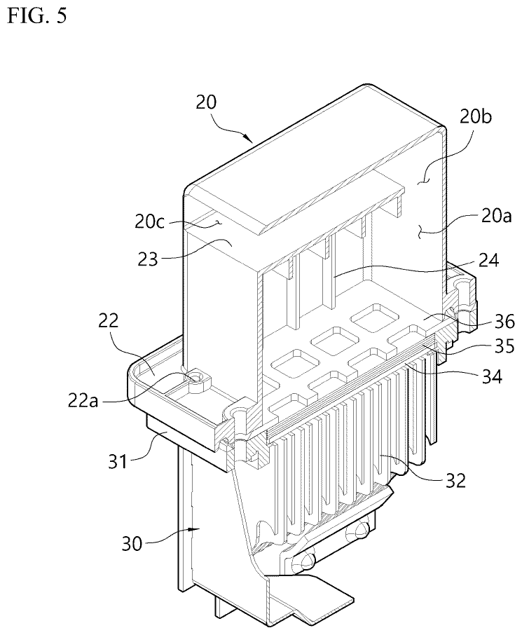

In this case, here, the shield panel 34 is described as a component of the arc extinguishing unit, but the shield panel 34 may be designed in a structure that is not coupled to the inside of the arc extinguishing unit but is coupled to a lower end of the arc cover 20 in terms of a position of the shield panel according to another embodiment. That is, it is obvious that the shield panel 34 may be designed in a structure that is coupled to or integrated with a lower end of the chamber 20a of the arc cover 20. In this case, referring to FIGS. 5, 6, and 8, an inner rib 24 may be vertically formed in an inner side surface of the arc cover 20 and the guide panel 23. A plurality of inner ribs 24 may be formed at regular intervals.

In this case, the inner rib 24 may be formed in an arch shape. That is, a corner of the arc cover 20 may be formed to protrude further inward than other parts.

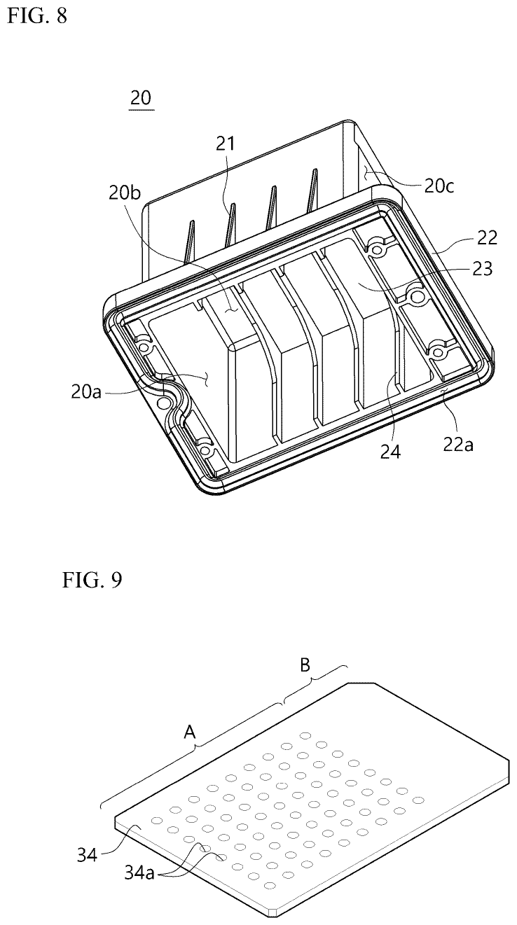

In this case, referring to FIG. 8, an outer rib 21 may be vertically formed on an outer side surface of the arc cover 20, and the outer rib 21 and the inner rib 24 may be formed at positions corresponding to each other. The inner rib 24 and the outer rib 21 may be formed at the corresponding positions, which may more firmly cope with pressure of the gas applied to the side surface.

In this case, a sealing member may be installed between the arc extinguishing unit 30 and the arc cover 20 to prevent leakage of the high-temperature gas. Referring to FIG. 8, a groove 22a for the sealing member may be formed on a lower surface of a flange part of the arc cover 20, and the sealing member made of rubber may be inserted into the groove 22a and then assembled with a body and a piece of the arc extinguishing unit 30. Thus, the high-temperature gas is prevented from leaking between the assembled portions of the arc extinguishing unit 30 and the arc cover 20.

Referring to FIG. 2, a state in which the arc cover 20 and the arc extinguishing unit 30 are separated from the air circuit breaker 10 is illustrated. The arc extinguishing unit 30 may be assembled in a manner of being inserted into the case 11 of the air circuit breaker 10, and the arc cover 20 may be assembled to form the internal chamber 20a in an upper space thereof in a state in which the arc extinguishing unit 30 is inserted. In this case, because the outlet 20c is formed on a front upper side of the arc cover 20, a probability that the gas exhausted from the arc cover 20 comes into contact with the rear busbar 50 is very low. Further, it is general that a cabinet is installed to be spaced a predetermined distance from the case 11 of the air circuit breaker 10, but the gas discharged to the arc cover 20 has already lost conductivity, and thus secondary accidents can be prevented.

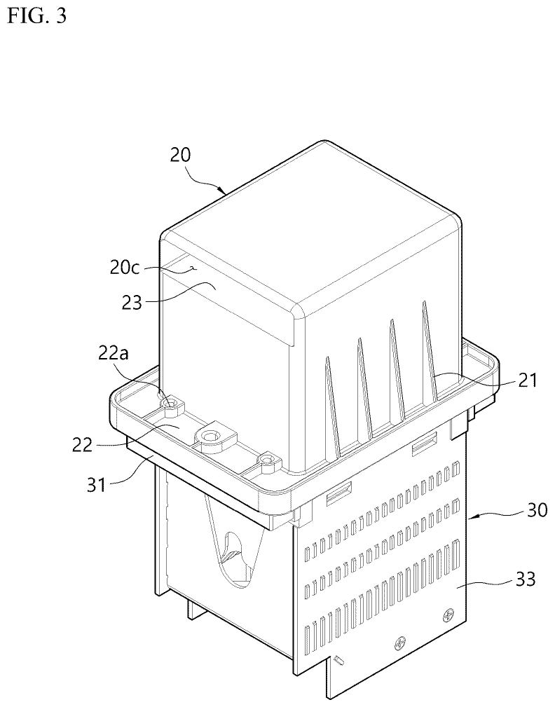

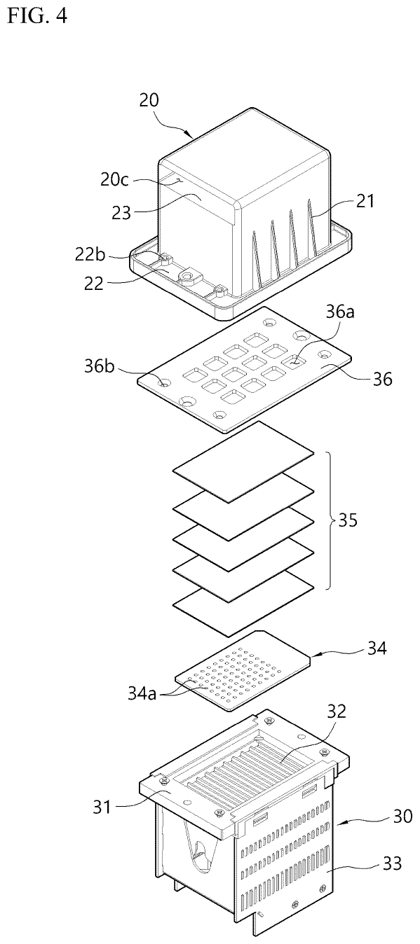

Referring to FIGS. 3 and 4, a state in which the arc cover 20 and the arc extinguishing unit 30 of the air circuit breaker 10 are assembled with each other is illustrated. The arc extinguishing unit 30 is positioned on a lower side, and the arc cover 20 is positioned on an upper side. Thus, the high-temperature gas extinguished by the arc extinguishing unit 30 has a high temperature and thus moves upward even without a separate pressure providing unit. That is, the gas passing through the arc extinguishing unit 30 rises to the internal chamber 20a of the arc cover 20. The arc cover 20 and the arc extinguishing unit 30 are assembled by pieces. Thus, in a state in which a flange 22 of the arc cover 20 and a frame 31 of the arc extinguishing unit 30 are in close contact with each other, the sealing member may be interposed therebetween, and the arc cover 20 and the arc extinguishing unit 30 may be assembled by the pieces. Thus, an assembly connection portion between the arc extinguishing unit 30 and the arc cover 20 is sealed to prevent leakage of the gas. In the arc extinguishing unit 30, the support plates 33 are assembled on both surfaces of the frame 31, and support the plurality of grids 32 installed therebetween. In this location, the arc is extinguished and thus a lot of heat and pressure are generated. The shield panel 34 may be installed at an upper side of the grids 32 in the frame 31 of the arc extinguishing unit 30. The plurality of through-holes 34a may be formed in the shield panel 34, and the amount of high-temperature gas supplied to the arc cover 20 may be determined according to the design of the through-holes 34a.

Here, referring to FIG. 9, the shield panel 34 includes the open part A and the closed part B as described above. A plurality of mesh members 35 are installed on an upper side of the shield panel 34, and the upper cover panel 36 is assembled with the frame 31 on the upper side of the mesh members 35. The through-hole 36a may be also formed in the upper cover panel 36, allow the amount of air to be controlled, and serve to support components assembled in a lower portion from the upper side. The arc cover 20 is placed on the upper cover panel 36, and the flange 22 of the arc cover 20 is piece-assembled with the upper cover panel 36 using a piece hole 22b. The plurality of outer ribs 21 may be formed on the side surface of the arc cover 20 to help reinforce a strength of the side surface of the arc cover 20, and the outlet 20c may be formed on a front surface of the arc cover 20 to exhaust the gas that has lost conductivity to the outside of the chamber 20a of the arc cover 20.

Referring to FIGS. 5 and 6, the flow of air inside the arc cover 20 is illustrated. The high-temperature gas flowing upward from the arc extinguishing unit 30 rises to the front side, that is, only the part A and the part B is closed, and thus the gas cannot pass therethrough. That is, the gas of the arc extinguishing unit 30 passes through the shield panel 34, does not pass through the closed part B, passes through only the open part A in which the through-hole 34a is formed, and thus rises into the chamber 20a. The gas rises vertically along the inner rib 24 and then meets the guide panel 23. The high-temperature gas does not move directly rearward along the guide panel 23 but moves beyond the arch-shaped inner rib 24. Thus, a time during which the gas stays inside the chamber 20a is further increased. The gas passes beyond all the inner ribs 24, passes through the opening 20b formed by the guide panel 23 and a rear surface of a body of the arc cover 20, moves forward again by pressure, and is then exhausted to the outlet 20c. Thus, the high-temperature gas flows along a passage as illustrated by an arrow in FIG. 6. In this case, the high-temperature gas may not be directly discharged to the outside of the arc cover 20 but may flow along a passage that is bent several times, then be exhausted, and thus be exhausted while conductivity thereof is lost. Here, the flow of a fluid illustrated in FIG. 6 may be achieved by the shield panel 34 and the guide panel 23, and the inner ribs 24 may act as a cause of helping this flow.

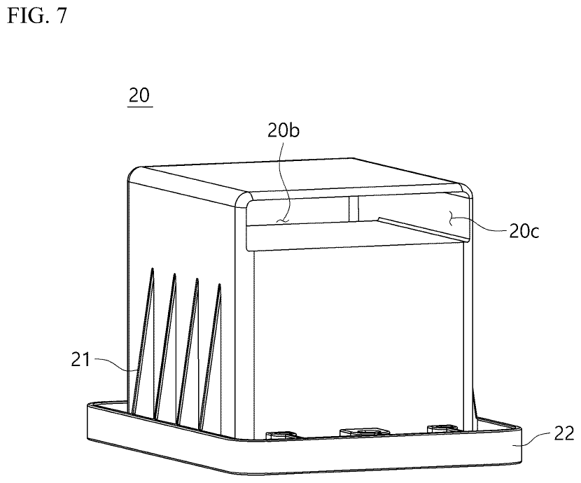

Referring to FIGS. 7 and 8, an outer appearance of the arc cover 20 is illustrated. The plurality of outer ribs 21 are formed on both side surfaces of the arc cover 20, and as described above, the outer rib 21 and the inner rib 24 are formed at the corresponding positions. Thus, the shape of the arc cover 20 may be firmly maintained, and thus the arc cover 20 may withstand the pressure of the gas rising from the arc extinguishing unit 30. As described above, the groove 22a is formed in the flange 22 of the arc cover 20, and the sealing member is assembled together.

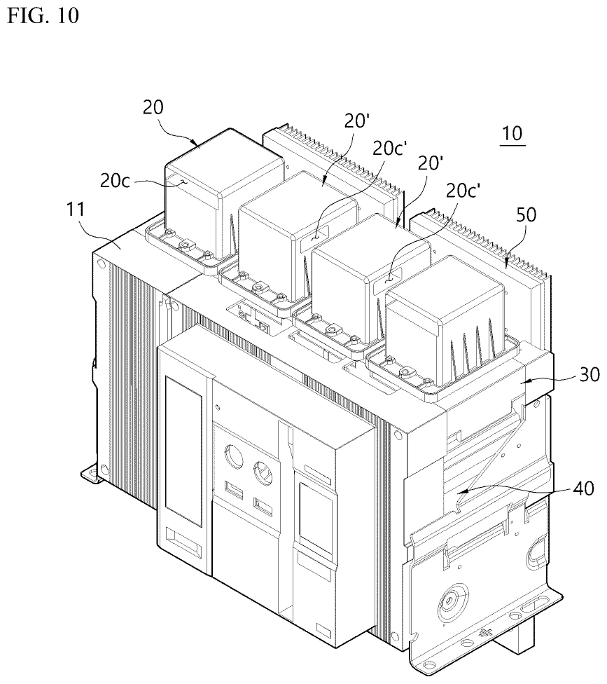

Meanwhile, referring to FIG. 10, an air circuit breaker 10 according to another embodiment of the present invention is illustrated. Here, it is illustrated that outlets 20c′ of an arc cover 20′ are formed on both side surfaces of the arc cover 20′. Among the four arc covers 20 and 20′, the outlets 20c are formed on front surfaces of the arc covers 20 at both ends, which is similar to the above-described embodiment, and the outlets 20c′ are formed on both side surfaces of the two arc covers 20′ at a center thereof. That is, this is a structure in which the extinguished gas may be discharged in wider directions than a case in which the entire arc cover exhausts the gas to the front surface.

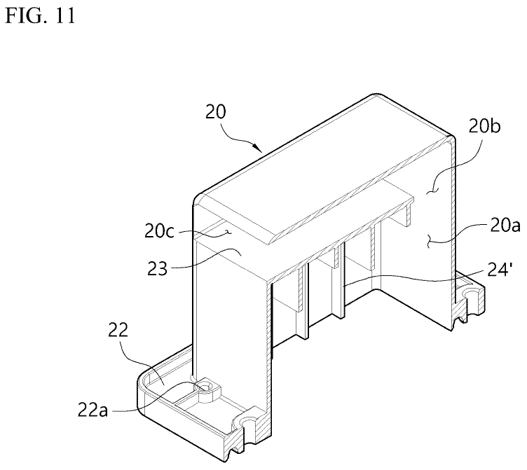

Meanwhile, referring to FIG. 11, the arc cover 20 according to another embodiment of the present invention is illustrated. Here, the arc cover 20 may have a plurality of inner ribs 24′, and each inner rib 24′ may protrude at a different height. The four inner ribs 24′ are formed in an arch shape and have different protruding heights. In this way, as the inner ribs 24′ are formed at different heights, the passage of the gas may be made more complicated, and accordingly, an exhaust time may be increased, thereby helping to lose the conductivity of the gas. In FIG. 11, the heights of the inner ribs in the vertical direction are changed, but it is obvious that the protrusion lengths of the inner ribs protruding from the side surfaces may be changed and applied.

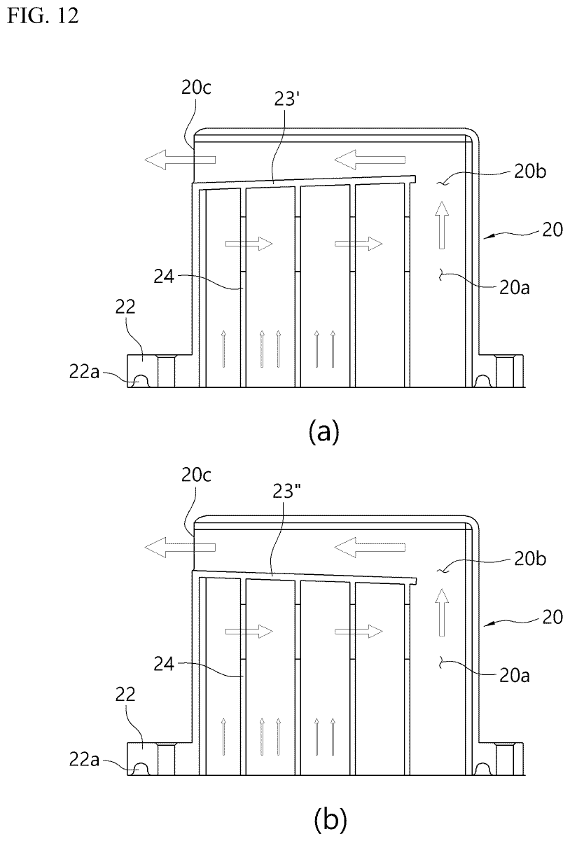

Meanwhile, referring to FIG. 12, the arc cover 20 according to another embodiment of the present invention is illustrated. In the above-described embodiment, the guide panel 23 of the arc cover 20 is installed in a horizontal direction, but herein, the guide panel 23 may be installed to be inclined with respect to a horizontal plane. In the case of FIG. 12A, the guide panel 23′ is inclined forward, and in the case of FIG. 12B, the guide panel 23″ is inclined rearward. Efficiency according to the inclination of each of the guide panels 23′ and 23″ can be optimized through an experiment in consideration of heights of the guide panels 23′ and 23″, a height or cross-sectional area of an opening, or the like.

Although the embodiments of the present invention have been described, the spirit of the present invention is not limited to the embodiments presented in the present specification. Those skilled in the art who understand the spirit of the present invention can easily propose other embodiments by adding, changing, deleting, or the like of components within the same scope of the spirit. Further, these other embodiments also belong to the scope of the spirit of the present invention.

The present invention may be applied to an air circuit breaker.

1. An air circuit breaker having an arc cover, comprising:
an operation unit in which arc is generated by operating a movable contact with respect to a stationary contact;
an arc extinguishing unit installed on an upper side of the operation unit and configured to primarily extinguish the arc; and
an arc cover which is installed on an upper side of the arc extinguishing unit, has a chamber formed such that a high-temperature gas passing through the arc extinguishing unit stays therein, and has at least one guide panel partitioning an interior of the chamber into a plurality of parts and having an opening on one side thereof, and in which the high-temperature gas is discharged to an outlet in a first direction along a passage guided by the guide panel.

2. The air circuit breaker of claim 1, wherein, the arc cover is formed such that a cross-sectional area of an inlet through which the high-temperature gas is introduced is greater than a cross-sectional area of the outlet.

3. The air circuit breaker of claim 1, wherein the guide panel of the arc cover is installed horizontally or inclined with respect to a horizontal plane.

4. The air circuit breaker of claim 1, wherein an inner rib is vertically formed in an inner side surface of the arc cover and the guide panel.

5. The air circuit breaker of claim 4, wherein the inner rib is formed in an arch shape.

6. The air circuit breaker of claim 4, wherein the inner rib is formed as a plurality of inner ribs, and each inner rib protrudes at a different height.

7. The air circuit breaker of claim 4, wherein an outer rib is vertically formed on an outer side surface of the arc cover, and the outer rib and the inner rib are formed at positions corresponding to each other.

8. The air circuit breaker of claim 1, wherein the guide panel is formed as a plurality of guide panels.

9. The air circuit breaker of claim 1, wherein the outlet in the first direction is formed on a front upper side or both side surfaces of the air circuit breaker.

10. The air circuit breaker of claim 1, wherein a sealing member is installed between the arc extinguishing unit and the arc cover to prevent the high-temperature gas from leaking.

11. The air circuit breaker of claim 1, wherein a shield panel, in which a plurality of through-holes are formed, is installed between the arc extinguishing unit and the arc cover to control a flow rate of the gas.

12. The air circuit breaker of claim 11, wherein the shield panel is coupled to or integrally formed with a lower end of the arc cover.

13. The air circuit breaker of claim 11, wherein a closed part of the shield panel in which the through-holes are not formed is positioned below an opening formed by the guide panel.
